(19) United States
(12) Patent Application Publication
(10) Pub. No.: US 2005/0108460 A1
(43) Pub. Date: May 19, 2005

(54) Partial bank DRAM refresh

(75) Inventor: Howard S. David, Portland, OR (US)

Correspondence Address: Pillsbury Winthrop LLP;Intellectual Property Group, 1600 Tysons Boulevard, McLean, VA, 22102, US

(73) Assignee: Intel Corporation, Santa Clara, CA (US)

(21) Appl. No.: 10/713,486

(22) Filed: Nov. 14, 2003

(51) Int. Cl. G06F 12/00

(52) U.S. Cl. 711/5; 711/105

(57) ABSTRACT

A “partial refresh command” is used to refresh a fraction of the banks in a multi-bank DRAM. In a first implementation the command refreshes one half of the banks. In a second implementation the command refreshes one quarter of the banks. The power drawn by the upper or lower bank refresh on the eight bank DRAM is the same as the power drawn by an “all bank” refresh on a four bank DRAM, without requiring the refresh period to be extended.

### BACKGROUND OF THE INVENTION

1. Field of the Invention

The present invention relates to dynamic random access memory (DRAM), and in particular to refreshing techniques.

2. Discussion of the Related Art

Memory devices are widely used in many electronic products and computers to store data. A memory device includes a number of memory cells. A DRAM device operates by storing charge on a capacitor at each memory location. Ultimately, the capacitor loses the charge over time and therefore needs to be periodically refreshed to its original level, a 1 or 0. All of the memory cells must be refreshed within one refresh period, t_{REF}, which may be for example 64 ms. Refreshing is accomplished by doing a row access for every row in the memory device. In a refresh cycle, all of the capacitors in one or more rows are first read, and then written back to, restoring full charge to the capacitor. The rows and columns of a DRAM device may be partitioned into multiple banks to reduce the large DRAM arrays into smaller segments.

In typical DRAMs, data is not directly transmitted from the storage cells. Rather, data may be transferred to sense amplifiers prior to transmission. The sense amplifiers may only store one row of data. If an operation is to be performed on a row of data other than the currently accessed row, two operations must be performed. The first operation, a precharge operation, occurs when pairs of bit lines within the memory are equalized to a midpoint voltage level. Secondly, a sense operation occurs when data in the row on which the operation is to be performed is transferred to the sense amplifiers. The DRAM device is said to be in a closed state between the precharge operation and the subsequent sense operation. At all other times, the DRAM is said to be in an open state.

A row access operation is performed in four steps. First, a row is opened, or turned on, in the sense operation. Turning on a row of transistors that connect one row of storage cells to one row of sense amps has the effect of draining most of the charge from the storage cells, which in turn moves the bit lines slightly away from their precharged neutral level. Second, after the sense amps have reached their stable level, another set of transistors are turned on which allow the sense amps to re-drive full data levels (0 or 1) on to the bit lines. The storage cells are also restored (refreshed) to their full levels. Third, the transistors that connect the storage cells to the bit lines are shut off, and the page is considered closed. Finally, the bit lines are returned to their neutral Vdd/2 voltage by performing the precharge operation, using a precharge equalization transistor. If a refresh operation is performed, there is no need to select a particular bit with a column address. Further, data is not read at the pins of the device.

As the number of storage cells per memory bank, and the number of memory banks per device increases, the number of refresh commands issued by a memory controller increases, and the proportion of time spent refreshing the memory increases. This ultimately results in a refresh overhead that unacceptably impacts the performance of normal memory accesses. In order to reduce refresh overhead, it may be desirable to refresh a fraction of the banks for each refresh command. This approach may be called partial multibank refresh. With a given refresh command, a fraction of the banks may be either simultaneously or sequentially refreshed. To maximize overall system performance it may be more desirable to refresh banks simultaneously in order to minimize the time that bank resources are tied up. Additionally, as DRAM devices become larger, the time required from the refresh command until the next command, the AUTO-REFRESH command period t_{RFC}, grows substantially. The impact of increased t_{RFC} is an increase in the read latency of read requests that occur during the refresh itself. For a DRAM device with a larger number of banks, there will be times when the read and write activity is skewed to one portion or another of the DRAM. Performance may be improved if refreshes are done opportunistically to the portion of the DRAM not in use, with concurrent read or write operation to the remaining portion of the DRAM.

As microprocessor speed increases, memory access speed must also increase. At the same time, the number of memory banks per memory device continues to increase, for example from four banks to eight banks to sixteen banks. Using current DRAM technology, the refresh command causes all of the banks of the DRAM to be refreshed. With multi-bank memories more locations need to be refreshed at any given time, and refreshing draws more power in a shorter time for the larger multi-bank memories. Therefore, either the current required for an all-bank refresh operation will be roughly double, for example, for eight banks as compared to four banks, or the time required to perform the refresh operation will be approximately twice as long compared to the four bank refresh. Thus, current spikes can cause significant noise problems on the power line during a refresh operation, and a longer refresh will increase the latency of any reads that are waiting for the refresh to complete. What is needed is a partial refresh command that refreshes additional rows of a bank and a fraction of the banks of a DRAM per command.

### BRIEF DESCRIPTION OF THE DRAWINGS

FIG. 1 illustrates a block diagram of a computer system suitable for use with an embodiment of the invention;

FIG. 2 illustrates a block diagram of a SDRAM according to an embodiment of the present invention;

FIG. 3 is a timing diagram illustrating an auto refresh operation;

FIG. 4 illustrates a block diagram of a refresh counter according to an embodiment of the present invention;

FIG. 5 illustrates using an all bank refresh command to refresh 16 rows according to an embodiment of the present invention;

FIG. 6 illustrates using an upper/lower half bank refresh command to refresh 8 rows according to an embodiment of the present invention;

FIG. 7 illustrates using an upper/lower half bank refresh command to refresh 16 rows according to an alternative embodiment of the present invention;

FIG. 8 illustrates a flow chart diagram of a partial bank refresh to a portion of the banks occurring along with an activate operation followed by a read or write operation according to an embodiment of the present invention; and

FIG. 9 illustrates a memory controller according to an embodiment of the present invention.

### DETAILED DESCRIPTION

The present invention improves the performance of memory subsystems by providing a method to refresh a fraction of the banks in a DRAM in response to a given refresh command. Refreshing a fraction of the banks allows a degree of concurrency with reads and/or writes to the remaining banks in the DRAM which are not being refreshed. Additional performance may be gained because it is not necessary to close the pages of the banks that are not being refreshed, potentially reducing the read latency to the data in those banks. In embodiments of the present invention each refresh command refreshes half of the banks in the DRAM. For example, in one embodiment, each refresh command (refreshing half of the banks in the DRAM) does half as much work as an all-bank refresh command (for the same number of rows per bank), so that twice as many refresh commands are needed per refresh period t_{REF}. In a second embodiment, the number of refresh commands per refresh period t_{REF} stays the same as an all bank refresh, so that each refresh command refreshes twice as many rows per bank (as compared with the all bank refresh), thereby accomplishing as much work per refresh command as an all-bank refresh command would.

As discussed above, DRAM devices require periodic refresh operations to retain data in its storage cells. A refresh operation consists of a row sense operation and a row precharge operation. Each memory cell needs to be refreshed within the refresh period t_{REF}. A typical t_{REF} value may be 64 ms. Therefore, each row in each memory bank needs to be refreshed within t_{REF}.

As the number of banks per memory device increases and as the number of devices in memory systems increases, the number of precharge and refresh commands issued by a memory controller also increases. This ultimately results in a precharge and refresh overhead that unacceptably impacts the performance of normal memory accesses as measured by effective data bandwidth and memory access latency.

As discussed above, a problem caused by all-bank refreshing is the generation of current spikes. Each refresh operation for each bank requires a certain amount of supply current over time. For a row sense operation there is a large initial spike because the row sensing circuits have been designed to access cell data as quickly as possible in order to minimize the latency. With all-bank refreshing, multiple banks simultaneously conduct a row sense, thus, the current spike effect may be additive causing greater probability of circuit failure.

The present invention implements refreshing a fraction of the banks for each refresh command to reduce refresh overhead on the memory system bus. This approach is called partial multibank refreshing. With a given refresh command, either a fraction of the banks are simultaneously refreshed, or a fraction of the banks are sequentially refreshed from the same command. To maximize overall system performance it may be more desirable to refresh banks simultaneously in order to minimize the time that bank resources are tied up. Within each bank, it is also desirable to refresh multiple rows, either simultaneously or in a staggered fashion.

In an embodiment of the present invention, the generation of row and bank addresses during refresh is split between on-chip and external commands. A row counter is provided on the memory chip, with the row counter being used for refresh operations, both normal and self-refresh. Only the bank address needs to be sent over the memory bus.

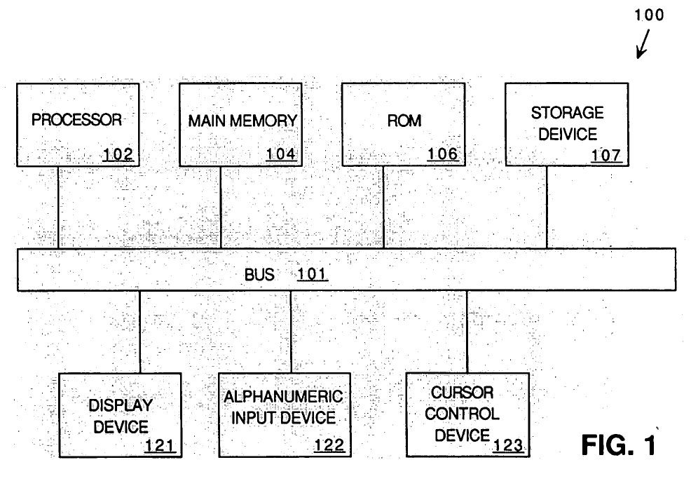

FIG. 1 is a block diagram of a computer system suitable for use with the invention. Computer system 100 comprises bus 101 or other device for communicating information, and processor 102 coupled with bus 101 for processing information. Computer system 100 further includes synchronous dynamic random access memory (SDRAM) or other dynamic storage device 104 (referred to as main memory), coupled to bus 101 for storing information and instructions to be executed by processor 102. Main memory 104 also can be used for storing temporary variables or other intermediate information during execution of instructions by processor 102. Computer system 100 also comprises read only memory (ROM) and/or other static storage device 106 coupled to bus 101 for storing static information and instructions for processor 102. Data storage device 107 is coupled to bus 101 for storing information and instructions.

Data storage device 107 such as magnetic disk or optical disc and corresponding drive can be coupled to computer system 100. Computer system 100 can also be coupled via bus 101 to display device 121, such as a cathode ray tube (CRT) or liquid crystal display (LCD), for displaying information to a computer user.

Alphanumeric input device 122, including alphanumeric and other keys, is typically coupled to bus 101 for communicating information and command selections to processor 102. Another type of user input device is cursor control 123, such as a mouse, a trackball, or cursor direction keys for communicating direction information and command selections to processor 102 and for controlling cursor movement on display 121.

In one embodiment, processor 102 and one or more of the components coupled to bus 102, such as main memory 104, are source synchronous components. Of course, any one or more components of computer system 100 can be source synchronous. Thus, computer system 100 can be either a partially source synchronous or fully source synchronous environment. In one embodiment, computer system 100 is a differential-strobe source synchronous system in which complementary strobe signals are communicated in parallel with data signals over the bus. Alternatively, computer system 100 is a single-strobe source synchronous system in which a single strobe signal is communicated in parallel with data signals over the bus.

The 16 Mb generation of DRAM consisted of a single bank of memory, so that each refresh command would cause one row of the DRAM to be refreshed. With the introduction of the 64 Mb generation of synchronous DRAM (SDRAM), devices with four banks became available. DRAM performance was improved because a large degree of concurrency was allowed between the banks. The 64 Mb DRAM were designed so that each refresh command would refresh 4 rows of memory, one row in each bank. The time to perform the 4 refreshes, t_{RFC}=72-80 ns, was longer than the time for a single activate plus read/write cycle, to allow the refreshes to be staggered internally. The staggering prevents the large current spike that would occur if all banks were refreshed at exactly the same time. For the 64 Mb SDRAM, the refresh period t_{REF} was 64 ms, while the average time between refreshes t_{REFI} was 15.6 us.

The 4-bank 256 Mb generation of double data rate SDRAM (DDR SDRAM) doubled the size of the row (the page size) relative to the 64 Mb generation, from 512B to 1 KB, and doubled the number of rows (8192) in the device relative to the 64 Mb generation (4096), but left the basic operation unchanged: each refresh command caused one row of each bank to be refreshed. Since twice as many rows needed to be refreshed in the refresh period t_{REF} (64 ms), the average time between refreshes (the refresh interval) t_{REFI} was reduced from 15.6 us to 7.8 us, in going from the 64 Mb to the 256 Mb generation.

The 4-bank 512 Mb generation of DDR SDRAM doubled the size of each row relative to the 256 Mb generation, from 1 KB to 2 KB. Compared to the 256 Mb generation, the refreshes are the same, i.e., each refresh command refreshes all four banks, with a refresh interval t_{REFI} of 7.8 us. The larger page size does require a larger current to perform the refresh.

For the 4-bank 256 Mb generation, DDR and DDR2 (second generation) SDRAM have the same number of rows and banks, the same page size, and the same refresh requirements. However, starting with the 4-bank 512 Mb generation, DDR2 SDRAM has been defined with a different combination of page size, number of rows, and number of banks, compared to DDR SDRAM. The 4-bank 512 Mb generation of DDR2 SDRAM achieves its doubling of capacity by doubling the number of rows in each bank (16384), while leaving the page size fixed at 1 KB. Each refresh command causes two rows to be refreshed in each bank of memory. This is possible because there are actually multiple sets of sense amplifiers in each bank of memory. The maximum number of rows of a bit line inside the DRAM is physically limited to around 512 (2\hat{ }9 bits). A DDR2 512 Mb SDRAM has 14 row bits, which means there are 2\hat{ }(14−9)=32 sets of sense amplifiers in each bank. These 32 sets are logically wired together to form one bank, so that reading or writing is normally only allowed to one row of a bank at a time. Allowing two sets of sense amplifiers within the same bank to be used to refresh two rows within the same bank at mostly the same time may require a small change to the circuitry that connects the 32 sets of sense amplifiers. The total time for the refresh, t_{RFC} (105 ns), is increased.

The 8-bank 1 Gb generation achieves its doubling of capacity by doubling the number of banks, from 4 to 8, so that each refresh command must cause two rows to be refreshed in each bank to be refreshed, with a total of 16 rows to be refreshed for each refresh command. The total time for the refresh, t_{RFC} (127.5 ns), is increased to keep the current requirements roughly the same as the 512 Mb generation.

The 8-bank 2 Gb generation achieves its doubling of capacity by doubling the number of rows in each bank (32768), so that each refresh command must cause 4 rows to be refreshed in each bank to be refreshed, with a total of 32 rows to be refreshed for each refresh command. The total time for the refresh, t_{RFC} (195 ns), is also increased to keep the current requirements roughly the same as the 1 Gb generation.

The memory industry has not yet decided how the 4 Gb generation will achieve its doubling of capacity, i.e., it can be achieved by doubling either the page size, the number of rows, or the number of banks. If the refresh current is to stay roughly the same for the 4 Gb generation, there will be either an increase in t_{RFC} or a decrease in t_{REFI}, relative to the 2 Gb generation.

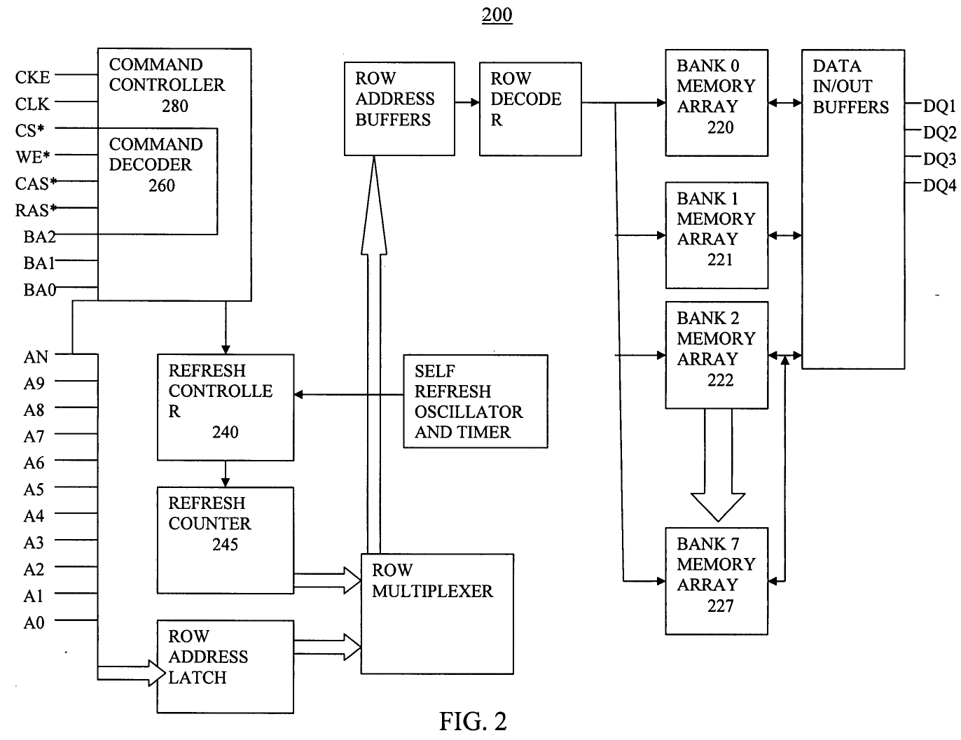

A synchronous dynamic random access memory (SDRAM) according to embodiments of the present invention is illustrated generally at 200 in FIG. 2 in block diagram form. The present invention is not limited to SDRAMs, as the present invention is equally applied to other types of memory devices. Only the circuitry relevant to the current discussion is shown. As illustrated in FIG. 2, SDRAM 200 may include 8 memory bank arrays, a bank 0 memory array 220 up to a bank 7 memory array 227 which all comprise storage cells organized in rows and columns for storing data.

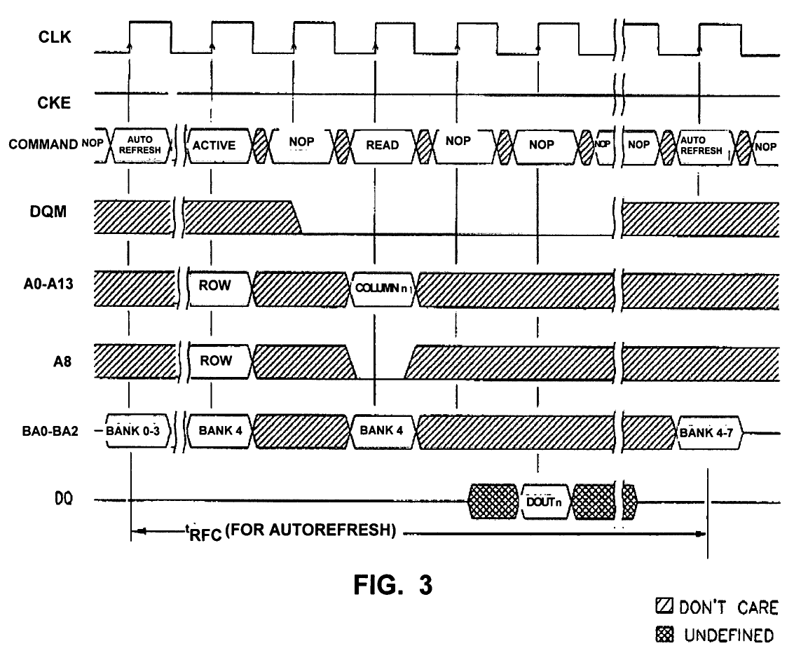

A system clock (CLK) signal is provided through a CLK input pin and a clock enable signal (CKE) is provided through a CKE input pin to SDRAM 200. The CLK signal is activated and deactivated based on the state of the CKE signal. All the input and output signals of SDRAM 200, with the exception of the CKE input signal during power down and self refresh modes, are synchronized to the active going edge of the CLK signal (See also FIG. 3).

A chip select (CS*) input pin inputs a CS* signal which enables, when low, and disables, when high a command decoder 260. The command decoder 260 is included in a command controller 280. The command decoder 260 receives control signals including a row access strobe (RAS*) signal on a RAS* pin, column access strobe (CAS*) signal on a CAS* pin, and a write enable (WE*) signal on a WE* pin. The command decoder 260 decodes the RAS*, CAS*, and WE* signals to place the command controller 280 in a particular command operation sequence. The command controller 280 controls the various circuitry of SDRAM 200 based on decoded commands such as during controlled reads or writes from or to bank 0 memory array 220 through bank 7 memory array 227. Bank address signals (BA0, BA1, BA2) are provided on separate BA input pins to define which of at least one memory bank array should be operated on by certain commands issued by the command controller 280.

Address inputs bits are provided on input pins A0-AN. Current DDR and DDRII specifications define up to 16 address pins, A0-A15. For example, 1 Gb SDRAM devices use input pins A0-A13. The row and column address input bits are multiplexed on the address input pins. During write transfer operations, data is supplied to SDRAM 200 via input/output pins (DQ1-DQ4). During read transfer operations, data is clocked out of SDRAM 200 via input/output pins DQ1-DQ4.

SDRAM 200 must be powered-up and initialized in a predefined manner. In addition, all memory bank arrays 220-227 must be precharged and placed in an idle state. The precharging of the memory bank arrays is preformed with a precharge command operation.

Two refresh commands are typically available in SDRAM 200, an AUTO-REFRESH command and a SELF-REFRESH command. The AUTO-REFRESH command is performed with a refresh controller 240 and a refresh counter 245 in a manner described below to refresh the memory bank arrays 220-227. The SELF-REFRESH command is performed with the refresh controller 240, a self-refresh oscillator and timer 260, and the refresh counter 245. The self-refresh oscillator and timer 260 internally generates a clock signal to provide internal timing for refreshes which occur in self-refresh mode.

An AUTO-REFRESH command is initiated by registering CS*, RAS* and CAS* low with WE* high. The AUTO-REFRESH command is non-persistent, and therefore must be issued each time a refresh is required. Addressing of the rows is generated by internal refresh controller 240 and refresh counter 245. Thus, the A0-AN address inputs are treated as “don't care” conditions during an AUTO-REFRESH command. In one embodiment of the SDRAM 200 (256 Mb DDR2) having 8192 rows, all 8192 rows need to be refreshed every 64 ms. Therefore, providing a distributed AUTO-REFRESH command approximately every 7.8 microseconds meets this refresh requirement and ensures that each row is refreshed.

An auto refresh operation in one embodiment of SDRAM 200 performed in a memory bank array specified by the BA signals (BA0, BA1, BA2) during auto refresh mode is illustrated in timing diagram form in FIG. 3. As indicated in FIG. 3, each auto refresh operation in this embodiment of SDRAM 200 is to at least one memory bank array specified by the state of the BA signals (BA0, BA1, BA2) provided on the BA pins.

Preferably, the AUTO-REFRESH commands are alternated between banks. However, more than one row in each of the specified banks may be auto refreshed before switching banks. In an embodiment of the present invention, refresh counter 245 counts partially through the rows of the at least one specified bank before a memory controller switches to other banks. In this embodiment, refresh counter 245 preferably counts through a specified number of rows from 0 to N prior to the memory controller switches banks. For example, in one embodiment, refresh counter 245 provides addresses for row 0 of the specified banks, then row 1 of the specified banks, then row 2 of the specified banks, . . . , and finally row N of the specified banks of SDRAM 200. In this embodiment, once at least one memory bank array is auto refreshed, some combination of the other memory bank arrays can be auto refreshed. The number of rows N per bank refreshed per AUTO-REFRESH command can be calculated from DRAM timing specifications:
Rows per refresh=Rows per bank*Number of banks* t_{REFI}/t_{REF}
t_{REFI}=average interval between refresh commands
t_{REF}=Refresh Period

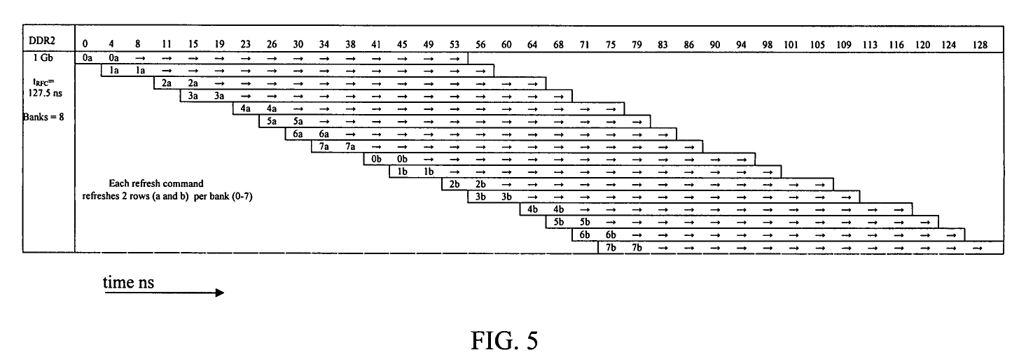

For example referring to FIG. 5, for an all bank refresh of a 1 Gb DDRII DRAM having 8 banks, 16384 rows per bank, t_{REFI}=7.8 us, and t_{REF}=64 ms.

Rows per refresh=8*16384*7.8 us /64 ms=16 (Each bank will have two rows refreshed per refresh command). If refreshing a row takes approximately t_{RC}=60 ns, and the row refreshes are staggered by about 4 ns, then a 1 Gb DDR2 refresh command would take 60+15*4=120 ns, roughly consistent with the DDR2 specification of 127.5 ns. Using the all bank refresh requires 8192 refresh commands per t_{REF}=64 ms. Note that the rows are refreshed in a staggered fashion per refresh command to prevent the large current spike that would occur if all rows were refreshed at exactly the same time. Table A includes data for various other DRAM devices.

TABLE A

| DDR2 DRAM | | | | row per bank per |
|---|---|---|---|---|
| Size | Banks | Rows/refresh | t_{RFC} | refresh |
| 256 Mb | 4 | 4 | 75 ns | 1 |
| 512 Mb | 4 | 8 | 105 ns | 2 |
| 1 Gb | 8 | 16 | 127.5 ns | 2 |
| 2 Gb | 8 | 32 | 195 ns | 4 |

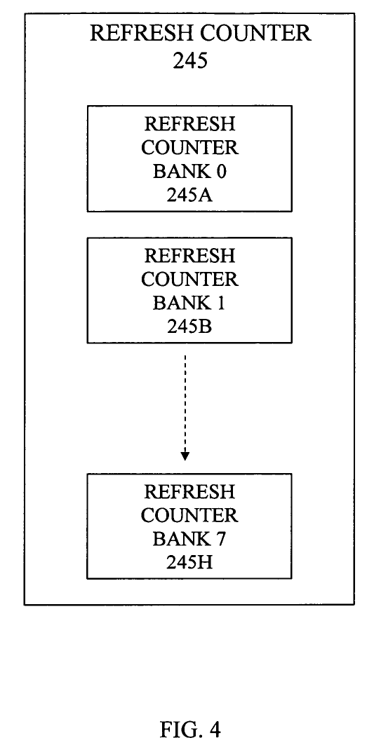

A refresh counter 245 employed in one embodiment of SDRAM 200 is illustrated in block diagram form in FIG. 4. This embodiment of SDRAM 200 includes a separate refresh counter portion for each memory bank array in the SDRAM. For example, as illustrated in FIG. 4, refresh counter 245 includes a refresh counter bank 0 portion 245A and a refresh counter bank 1 portion 245B, up to a refresh counter bank 7 portion 245H. If each memory bank array has 16384 rows, each refresh counter bank portion includes 14 bits to hold the existing row address currently being refreshed. This is in contrast to a single portion counter 245 which has one counter portion with 14 bits to address the 16382 rows of every memory bank array.

By having a refresh counter portion dedicated to each bank, the auto refresh operation can stop partially through the refreshing of rows in a given specified bank. For example, an auto refresh operation can be performed for row 0 through row 4 in bank 0, then switch to bank 4 to perform auto refreshes on row 0 through row 4 in bank 4. When the auto refresh operation returns to bank 0, the count held in refresh counter bank 0 portion 245A indicates that the refreshing was last performed on row 4 of bank 0, so that refreshing then begins in row 5 or whatever row was due to be refreshed prior to switching banks.

An auto refresh operation may be performed on at least one specified memory bank array of an SDRAM 200 using BA signals (BA), BA1, BA2) during auto refresh mode as described in more detail below. In embodiments of the present invention, other commands can be performed on the memory bank arrays not being refreshed.

A new “partial refresh command” is defined in Table B for an SDRAM with eight banks. For these eight bank SDRAM parts, a refresh command with BA2 driven low will cause the lower four banks of the DRAM to be refreshed. A refresh command with BA2 driven high will cause the upper four banks of the DRAM to be refreshed. Although this multibank addressing scheme naturally supports the most straight-forward sequential address assignment to banks, other assignments are applicable.

TABLE B

| BA0 | BA1 | BA2 | Refreshed Bank(s) |
|---|---|---|---|
| DON'T CARE | DON'T CARE | Low¹ | Banks 0˜3 |
| DON'T CARE | DON'T CARE | High | Banks 4˜7 |

Note
¹BA2 = DON'T CARE for four bank devices

The advantages of the present invention are two fold. The power drawn by the upper or lower bank refresh on the eight bank part will be the same as the power drawn by an “all bank” refresh on a four bank part, without requiring the refresh period to be extended in time. This eliminates the problem that refreshing eight banks simultaneously would ordinarily cause an instantaneous current draw that exceeds the limits of the package and die.

In addition, the upper/lower refresh command allows half of the banks to remain open and accessible for reads and writes during the refresh of the other half of the banks. Furthermore, the refresh time is left equal to the refresh time for a four bank device, minimizing the chance of a large queue of read requests to be waiting for the refresh to complete.

An additional embodiment of the present invention defines the partial refresh command to cause either one fourth of the banks to be refreshed, or optionally, one half of the banks to be refreshed. Table C below indicates how such a command is implemented for an 8-bank SDRAM. Again, this multibank addressing scheme naturally supports the most straight-forward sequential address assignment to banks, other assignments are applicable.

TABLE C

| BA0 | BA1 | BA2 | Refreshed Bank(s) |
|---|---|---|---|
| LOW | LOW | LOW | Banks 0˜2 |
| LOW | HIGH | LOW | Banks 1˜3 |
| HIGH | LOW | LOW | Banks 4˜5 |
| HIGH | HIGH | LOW | Banks 6˜7 |
| LOW | LOW | HIGH | Banks 0˜3 |
| HIGH | LOW | HIGH | Banks 4˜7 |
| DON'T CARE | HIGH | HIGH | Reserved |

The present invention is extendable to a 16-bank SDRAM. The general case is a refresh command that causes “M banks” to be refreshed on an “N bank” DRAM.

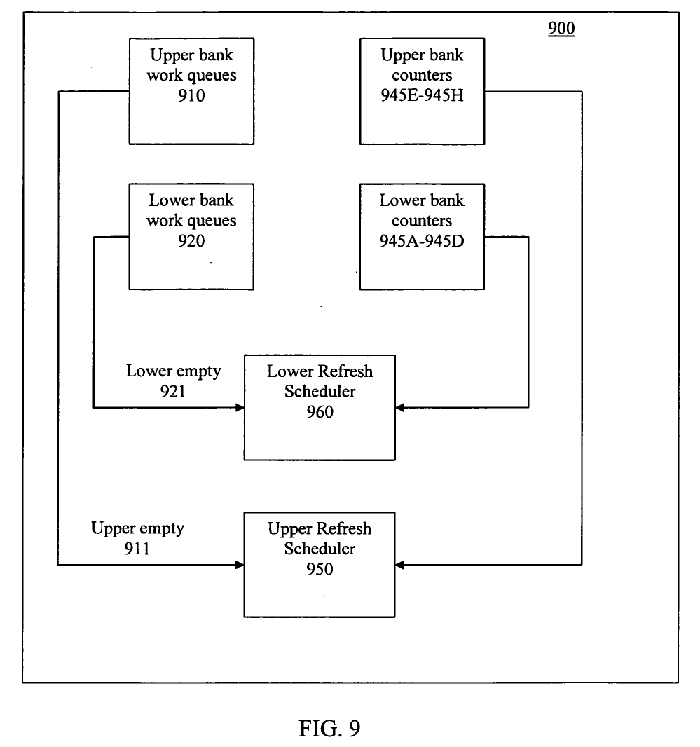

FIG. 9 illustrates a memory controller according to an embodiment of the present invention. Memory controller 900 maintains separate work queues, upper bank work queues 910 and lower bank work queues 920 for each bank of the SDRAM 200. The memory controller 900 may also maintain refresh counter portions 945A-945H for each memory bank array in the SDRAM 200. The refresh counter portions 945A-945H may be organized into upper bank counters 945E-945H and lower bank counters 945A-945E. Memory controller 900 may utilize upper bank counters 945E-945H and lower bank counters 945A-945E to keep track of upper bank refreshes separately from lower bank refreshes. Memory controller 900 may also utilize an upper bank refresh scheduler 950 and a lower bank refresh scheduler 960. The upper bank refresh scheduler 950 and the lower bank refresh scheduler 960 may operate utilizing a credit or debit model.

A credit model refresh scheduler begins by performing up to eight refreshes in a row (a credit balance), then uses up this balance as needed. The credit model scheduler generally tries to restore the credit balance back to eight whenever the memory subsystem is idle. A debit model refresh scheduler begins with a zero balance, and allows the controller to fall behind by as many as eight refreshes (a debit balance). The debit model scheduler generally tries to reduce the debit balance to zero whenever the memory subsystem is idle. The result of each type of scheduler is to perform refreshes as much as possible during the memory subsystem idle times.

For example, using the credit model approach, either scheduler 950, 960 may be connected to a counter 945A-945D, 945E-945H, respectively, with a maximum count of 8 that is incremented each time a refresh occurs, and decremented every tREFI nsec. If the counter=8, then no more refreshes are needed for a specified time. If the counter=0, then a priority refresh has to occur (upper or lower). If the counter is between 1 and 7, then a refresh can be scheduled opportunistically whenever the upper empty signal 911 or lower empty signal 921 are asserted.

In embodiments of the present invention, the memory controller 900 in communication with the SDRAM 200 may keep track of in which bank the AUTO-REFRESH command is being performed. In an eight bank system, the knowledge of the current banks being refreshed may be maintained by the memory controller 900. The memory controller 900 specifies the bank(s) to be refreshed at the initiation of an AUTO-REFRESH command with the BA signals (BA0, BA1, BA2) on the BA pins in a eight memory bank device. In embodiments of the present invention, only the banks specified to be refreshed need to be idle at a given time. Thus, other commands may be performed on other banks not being refreshed during an auto refresh operation on the specified banks. Other embodiments of the present invention may include restrictions as to which DRAM commands may be performed concurrently with the refresh command, or concurrently during a specified phase of the refresh cycle t_{RFC}. For example, reads, writes and precharges may be allowed, but activate may be disallowed, in which case, pages must be left open in order for work to be done during the partial bank refresh.

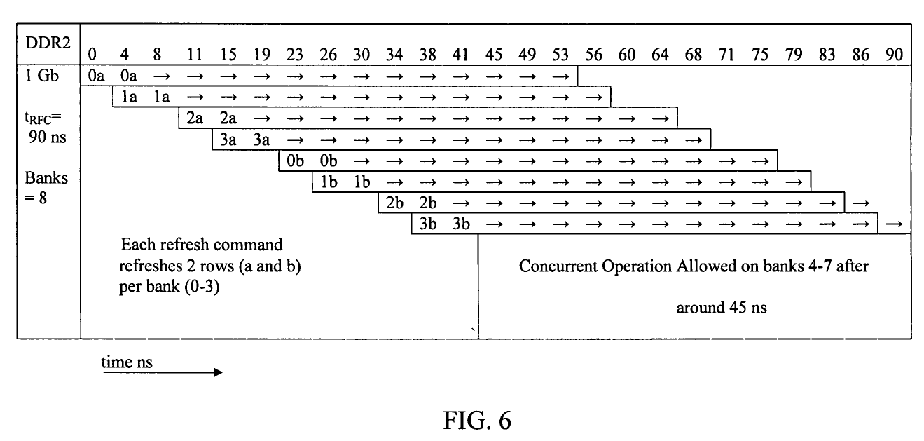

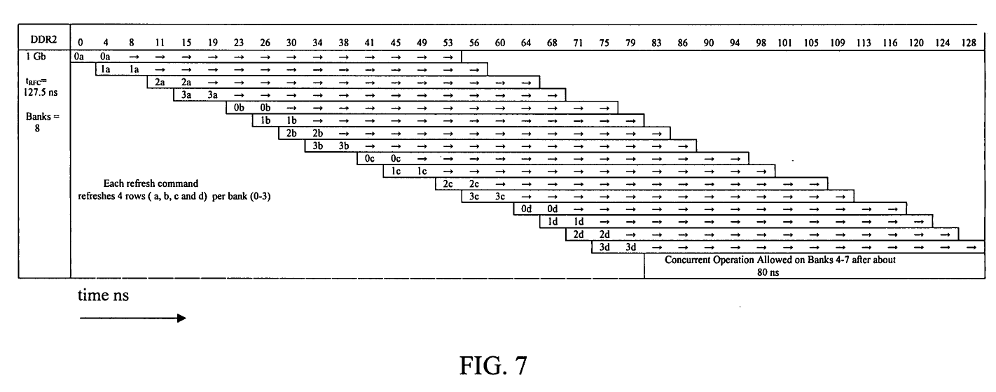

The t_{RFC} time, shown in FIG. 3, representing the command period from a refresh to a refresh or from a refresh to an ACTIVE command can be utilized to perform commands in banks not being refreshed. For example, the auto refreshing of the banks 0-3 memory arrays while an active and a read operation are performed in the bank 4 memory array is illustrated in timing diagram form in FIG. 3 and graphically illustrated in FIG. 6 and FIG. 7. As illustrated in FIG. 3, an auto refresh command is started by specifying banks 0-3 using the “lower bank refresh command” i.e., a refresh command with BA2 driven low will cause the lower four banks of the SDRAM to be refreshed. Subsequently, an ACTIVE command is started in bank 4 to activate the rows of the bank 4 memory array. As illustrated in FIG. 6, the concurrent operation initiated by the ACTIVATE command to bank 4 begins after approximately 45 ns. FIG. 7 illustrates the concurrent operation initiated by the ACTIVATE command to bank 4 begins after approximately 80 ns. A read command with a read latency of two is then performed to read data out from column n of the activated row. This transfer operation is performed before an auto refresh command is started by specifying banks 4-7 using the “upper bank refresh command” i.e., a refresh command with BA2 driven high will cause the upper four banks of the SDRAM to be refreshed.

FIG. 3 shows an ACTIVE command and a READ command, but it will be understood that a write operation which writes data into SDRAM 200 or other operation could also be performed between the two AUTO-REFRESH commands during the t_{RFC} time. In addition, the read operation is shown for one column of data, but may be extended to apply to a burst of length two, four, eight, or full page if the operation could be performed in between the two AUTO-REFRESH commands in the time represented by t_{RFC}. The embodiments of SDRAM 200 described above refer to an eight memory bank device, but the present invention applies to any multi-bank synchronous memory device such as a sixteen bank memory device.

FIG. 5 illustrates using an all bank refresh command to refresh 16 rows according to an embodiment of the present invention. For example, a 1 Gb, 8 bank DDR2 SDRAM 200 is refreshed by an all bank refresh command where 2 rows per bank are refreshed per refresh command. FIG. 5 illustrates that during the time t_{RFC}=127.5 ns, 2 rows per bank, row a and row b, for banks 0-7 are refreshed in a staggered fashion. Note that no concurrent operations take place. Thus, 8192 refresh commands are issued by the memory controller 900 per t_{REF}=64 ms.

FIG. 6 illustrates using a lower half bank refresh command to refresh 8 rows according to an embodiment of the present invention. For example, a 1 Gb, 8 bank DDR2 SDRAM 200 is refreshed by a lower half bank refresh command where 2 rows per bank are refreshed per refresh command for 4 banks. FIG. 6 illustrates that during the time t_{RFC}=90 ns, 2 rows per bank, row a and row b, for banks 0-3 are refreshed in a staggered fashion. For this embodiment twice as many refresh commands (16,384) would be required as compared to the all bank refresh (8192) described above to refresh all the rows in all 8 banks in t_{REF}=64 ms. However, note that concurrent operations on banks 4-7 is achievable after approximately 45 ns and lasting for approximately 45 ns. The 45 ns delay period allows all 8 rows to begin the refresh operation before concurrent operations begin. This is required to prevent the concurrent operations, such as an activate operation which draws significant current, to occur during the beginning of a refresh operation. Also note that the rows are refreshed in a staggered fashion per refresh command to prevent the large current spike that would occur if all rows were refreshed at exactly the same time.

FIG. 7 illustrates using a lower half bank refresh command to refresh 16 rows according to an alternative embodiment of the present invention. For example, a 1 Gb, 8 bank DDR2 SDRAM 200 is refreshed by a lower half bank refresh command where 4 rows per bank are refreshed per refresh command. FIG. 7 illustrates that during the time t_{RFC}=127.5 ns, 4 rows per bank, rows a, b, c, and d for banks 0-3 are refreshed in a staggered fashion. For this embodiment an equal number of refresh commands (8192) would be required as compared to the all bank refresh (8192) described above to refresh all the rows in all 8 banks in t_{REF}=64 ms. However, note that concurrent operations on banks 4-7 is achievable after approximately 80 ns and lasting for approximately 50 ns. The 80 ns delay period allows all 16 rows to begin the refresh operation before concurrent operations begin. Again, this is required to prevent the concurrent operations, such as an activate operation which draws significant current, to occur during the beginning of a refresh operation. Also note that the rows are refreshed in a staggered fashion per refresh command to prevent the large current spike that would occur if all rows were refreshed at exactly the same time.

The embodiments shown in FIG. 6 and FIG. 7 illustrate the tradeoff between using twice as many refresh commands to achieve a shorter time period before concurrent operations are allowed to begin (45 ns) versus an equal number of commands (compared to the all bank refresh) resulting in a longer time period before concurrent operations are allowed to begin (80 ns).

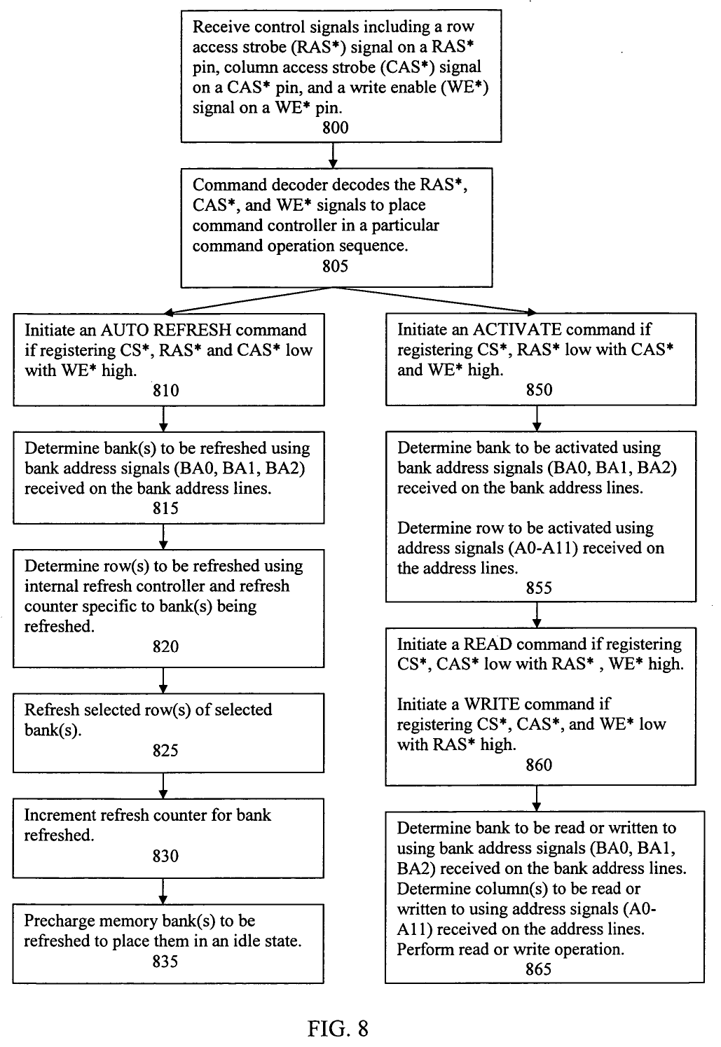

FIG. 8 illustrates a flow chart diagram of a partial bank refresh to a portion of the banks occurring along with an activate operation followed by a read or write operation to a portion of the banks not being refreshed. The SDRAM 200 receives 800 control signals including a row access strobe (RAS*) signal on a RAS* pin, column access strobe (CAS*) signal on a CAS* pin, and a write enable (WE*) signal on a WE* pin. The command decoder 260 decodes 805 the RAS*, CAS*, and WE* signals to place the command controller 280 in a particular command operation sequence. The command controller 280 will initiate 810 an AUTO-REFRESH command if registering CS*, RAS* and CAS* low with WE* high. The command decoder 260 determines 815 the bank(s) to be refreshed using bank address signals (BA0, BA1, BA2) received on the plurality of bank address lines. The internal refresh controller 240 and refresh counter 245 specific to bank(s) being refreshed determines 820 the row(s) to be refreshed. The selected row(s) of selected bank(s) is/are refreshed 825. The refresh counter for the bank refreshed is incremented 830. The command controller 280 precharges 835 the memory bank(s) to be refreshed to place them in an idle state.

In addition, other commands may be performed on other banks not being refreshed during an auto refresh operation on the banks specified to be refreshed. The SDRAM 200 receives 800 control signals including a row access strobe (RAS*) signal on a RAS* pin, column access strobe (CAS*) signal on a CAS* pin, and a write enable (WE*) signal on a WE* pin. The command decoder 260 decodes 805 the RAS*, CAS*, and WE* signals to place the command controller 280 in a particular command operation sequence. The command controller 280 may initiate 850 an ACTIVATE command to a bank not being refreshed if registering CS*, RAS* low with CAS* and WE* high. The command decoder 260 determines 855 the bank to be activated using bank address signals (BA0, BA1, BA2) received on the plurality of bank address lines and determines the row to be activated using address signals (A0-AN) received on the address lines. The command controller 280 may initiate 860 a READ command if registering CS*, CAS* low with RAS* and WE* high. Alternatively, the command controller 280 may initiate 860 a WRITE command if registering CS*, CAS*, and WE* low with RAS* high. The command decoder 260 determines 865 the bank to be read or written to using bank address signals (BA0, BA1, BA2) received on the bank address lines and determines the column(s) to be read or written to using address signals (A0-AN) received on the address lines. The SDRAM 200 then performs the read or write operation.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A method of operating a memory device having multiple memory bank arrays and being responsive to command signals and a plurality of bank address signals, the method comprising:
specifying at least one of a multiple of memory bank arrays to be refreshed using a plurality of bank address signals; and
initiating in response to first command signals an auto-refresh command controlling an auto refresh operation to the specified at least one of the multiple memory bank arrays.

2. The method of claim 1, wherein the specified at least one of the multiple memory bank arrays is specified in logic based on the plurality of bank address signals received.

3. The method of claim 1 further comprising:
initiating, before or during the auto refresh operation to the at least one of the specified memory bank arrays, a second command signal controlling a second operation, other than an auto refresh operation, to a second memory bank array of the multiple memory bank arrays, which is not one of the at least one of the specified memory bank arrays being refreshed.

4. The method of claim 1, wherein multiple rows per memory bank array are refreshed per auto-refresh command.

5. The method of claim 1, wherein multiple rows per memory bank array are refreshed in a staggered fashion per auto-refresh command.

6. The method of claim 1, wherein the method is performed using a synchronous dynamic random access memory device.

7. The method of claim 3, wherein the second operation is selected from the group consisting of activate operations, read operations, write operations and precharge operations.

8. An article comprising:
a storage medium having stored thereon instructions that when executed by a machine result in the following
specifying at least one of a multiple of memory bank arrays to be refreshed using a plurality of bank address signals; and
initiating in response to first command signals an auto-refresh command controlling an auto refresh operation to the specified at least one of the multiple memory bank arrays.

9. The article according to claim 8, wherein the specified at least one of the multiple memory bank arrays is specified in logic based on the plurality of bank address signals received.

10. The article according to claim 8, further comprising:
initiating, during the auto refresh operation to the at least one of the specified memory bank arrays, a second command signal controlling a second operation, other than an auto refresh operation, to a second memory bank array of the multiple memory bank arrays, which is not one of the at least one of the specified memory bank arrays being refreshed.

11. The article according to claim 8, wherein multiple rows per memory bank array are refreshed per auto-refresh command.

12. The article according to claim 8, wherein multiple rows per memory bank array are refreshed in a staggered fashion per auto-refresh command.

13. The article according to claim 8, wherein the method is performed using a synchronous dynamic random access memory device.

14. The article according to claim 10, wherein the second operation is selected from the group consisting of activate operations, read operations, write operations and precharge operations.

15. A memory device responsive to command signals and bank address signals, the memory device comprising:
multiple memory bank arrays, each memory bank array having storage cells; and
a command controller/decoder responsive to selected command signals and bank address signals to initiate an auto-refresh command controlling an auto refresh operation to at least one specified memory bank array of the multiple memory bank arrays.

16. The memory device of claim 15, wherein the at least one specified memory bank array of the multiple memory bank arrays is determined based on which memory bank arrays have been refreshed and a subsequent known order of refreshing the memory bank arrays.

17. The memory device of claim 16, wherein the at least one specified memory bank array of the multiple memory bank arrays is determined based on a command specifying which bank is to be next refreshed and a subsequent known order of refreshing the memory bank arrays.

18. The memory device of claim 16, wherein the command controller/decoder is responsive to selected command signals to initiate during the auto refresh operation to the at least one of the specified memory bank arrays a second command controlling a second operation, other than an auto refresh operation, to a second memory bank array of the multiple memory bank arrays, which is not one of the at least one of the memory bank arrays being refreshed.

19. The memory device of claim 15, further comprising a refresh counter for incrementing an address of a row to be refreshed, wherein the refresh counter has a separate counter portion for each of the multiple memory bank arrays.

20. The memory device of claim 15, wherein multiple rows per memory bank array are refreshed per auto-refresh command.

21. The memory device of claim 15, wherein multiple rows per memory bank array are refreshed in a staggered fashion per auto-refresh command.

22. The memory device of claim 15, wherein the memory device is a synchronous dynamic random access memory.

23. The memory device of claim 18, wherein the second operation is selected from the group consisting of activate operations, read operations, write operations and precharge operations.

24. A method of operating a memory device having multiple memory bank arrays and being responsive to command signals and a plurality of bank address signals, the method comprising:
specifying at least one of a multiple of memory bank arrays to be refreshed using a plurality of bank address signals;
initiating in response to first command signals an auto-refresh command controlling an auto refresh operation to the specified at least one of the multiple memory bank arrays, wherein multiple rows per memory bank array are refreshed per auto-refresh command; and
initiating, before or during the auto refresh operation to the at least one of the specified memory bank arrays, a second command signal controlling a second operation, other than an auto refresh operation, to a second memory bank array of the multiple memory bank arrays, which is not one of the at least one of the specified memory bank arrays being refreshed.

25. The method of claim 24, wherein the specified at least one of the multiple memory bank arrays is specified in logic based on the plurality of bank address signals received.

26. The method of claim 24, wherein multiple rows per memory bank array are refreshed in a staggered fashion per auto-refresh command.

27. The method of claim 24, wherein the method is performed using a synchronous dynamic random access memory device.

28. The method of claim 24, wherein the second operation is selected from the group consisting of activate operations, read operations, write operations and precharge operations.

29. The method of claim 28, wherein second command signals, to initiate an activate operation to open a page not to be refreshed, are issued by the memory controller after first command signals to initiate an auto-refresh command controlling an auto refresh operation to the specified at least one of the multiple memory bank arrays to be refreshed, in preparation for issuing second command signals to initiate read operations or write operations to the open page.

30. A memory controller for controlling a memory device having multiple memory bank arrays comprising:
a processor for scheduling and generating a plurality of bank address signals, first command signals, and second command signals, wherein the plurality of bank address signals specifies at least one of a multiple of memory bank arrays to be refreshed, the first command signals initiate an auto-refresh command controlling an auto refresh operation to the specified at least one of the multiple memory bank arrays, and the second command signals initiate, before or during the auto refresh operation to the at least one of the specified memory bank arrays, a second command controlling a second operation, other than an auto refresh operation, to a second memory bank array of the multiple memory bank arrays, which is not one of the at least one of the specified memory bank arrays being refreshed.

31. The memory controller of claim 30, wherein the specified at least one of the multiple memory bank arrays is specified in logic based on the plurality of bank address signals received.

32. The memory controller of claim 30, wherein multiple rows per memory bank array are refreshed per auto-refresh command.

33. The memory controller of claim 30, wherein multiple rows per memory bank array are refreshed in a staggered fashion per auto-refresh command.

34. The memory controller of claim 30, wherein the memory device is a synchronous dynamic random access memory device.

35. The memory controller of claim 30, wherein the second operation is selected from the group consisting of activate operations, read operations, write operations and precharge operations.

36. The memory controller of claim 35, wherein second command signals to initiate a second activate operation to open a page not to be refreshed are issued by the memory controller after first command signals to initiate an auto-refresh command controlling an auto refresh operation to the specified at least one of the multiple memory bank arrays to be refreshed, in preparation for issuing second command signals to initiate read operations or write operations to the open page.

37. A system comprising:
a memory device having multiple memory bank arrays; and
a memory controller for controlling the memory device, including a processor for scheduling and generating a plurality of bank address signals, first command signals, and second command signals, wherein the plurality of bank address signals specifies at least one of a multiple of memory bank arrays to be refreshed, the first command signals initiate an auto-refresh command controlling an auto refresh operation to the specified at least one of the multiple memory bank arrays, and the second command signals initiate, before or during the auto refresh operation to the at least one of the specified memory bank arrays, a second command controlling a second operation, other than an auto refresh operation, to a second memory bank array of the multiple memory bank arrays, which is not one of the at least one of the specified memory bank arrays being refreshed.

38. The system of claim 37, wherein the specified at least one of the multiple memory bank arrays is specified in logic based on the plurality of bank address signals received.

39. The system of claim 37, wherein multiple rows per memory bank array are refreshed per auto-refresh command.

40. The system of claim 37, wherein multiple rows per memory bank array are refreshed in a staggered fashion per auto-refresh command.

41. The system of claim 37, wherein the memory device is a synchronous dynamic random access memory device.

42. The system of claim 37, wherein the second operation is selected from the group consisting of activate operations, read operations, write operations and precharge operations.

43. The system of claim 42, wherein second command signals to initiate a second activate operation to open a page not to be refreshed are issued by the memory controller after first command signals to initiate an auto-refresh command controlling an auto refresh operation to the specified at least one of the multiple memory bank arrays to be refreshed, in preparation for issuing second command signals to initiate read operations or write operations to the open page.
